(19) United States
(12) Patent Application Publication
(10) Pub. No.: US 2025/0033415 A1
(43) Pub. Date: Jan. 30, 2025

(54) NON-PNEUMATIC TIRE HAVING CURVED SPOKES AND METHOD OF MAKING SAME

(71) Applicant: Bridgestone Americas Tire Operations, LLC, Nashville, TN (US)

(72) Inventor: Jonathan W. Fisk, Worcestershire (GB)

(21) Appl. No.: 18/716,712

(22) PCT Filed: Dec. 6, 2022
(86) PCT No.: PCT/US2022/080957

§ 371 Date: Jun. 5, 2024

Related U.S. Application Data
(60) Provisional application No. 63/294,515, filed on Dec. 29, 2021.

(51) Int. Cl. B60C 7/14; C21D 9/34

(52) U.S. Cl. CPC B60C 7/146; C21D 9/34

(57) ABSTRACT

A non-pneumatic tire includes a lower ring having a first diameter and an upper ring having a second diameter greater than the first diameter. The upper ring is substantially coaxial with the lower ring. The non-pneumatic tire further includes a plurality of curved, steel spokes extending between the lower ring and the upper ring. Each of the plurality of curved, steel spokes has a 0.2% yield strength of at least 1300 MPA, a tensile strength of at least 1400 MPa, and a hardness of at least 50 HRC.

### FIELD OF INVENTION

The present disclosure relates to a non-pneumatic tire having curved spokes and a method of making the same. More particularly, the present disclosure relates to a non-pneumatic tire having curved, steel spokes and a method of making the same.

### BACKGROUND

Various tire constructions have been developed which enable a tire to run in an uninflated or underinflated condition. Non-pneumatic tires do not require inflation, while “run flat tires” may continue to operate after receiving a puncture and a complete or partial loss of pressurized air, for extended periods of time and at relatively high speeds. Non-pneumatic tires may include a plurality of spokes, a webbing, or other support structure that connects an inner ring to an outer ring.

### SUMMARY OF THE INVENTION

In one embodiment, a method of making a nonpneumatic tire includes providing a rolled sheet of steel having a carbon content between 0.20% and 0.60%. The sheet has a thickness between 1.5 mm and 7 mm. The method further includes unwinding the rolled sheet of steel and tailor rolling the sheet of steel, such that the thickness of the sheet varies periodically along its length between a minimum thickness and a maximum thickness. The minimum thickness is at least 1.2 mm, and the maximum thickness is no more than 4.5 mm. The method also includes cutting the sheet into blanks containing one or more thick section and one or more thin section of steel. The length of each blank is equal to the width of the sheet. The method further includes rotating each blank through 90 degrees and roll forming each blank to form a curve along its width, with one or more thick section and one or more thin section in parallel along the length of the blank. The method also incudes heating each blank to a temperature between 950° C. and 1400° C., during a period of 2 to 10 seconds, and cooling each blank to a temperature below 200° C. within 10 seconds. The method further includes cutting each blank into a plurality of steel spokes having a width between 80 mm and 400 mm. The method also includes providing a lower ring and an upper ring and arranging the plurality of steel spokes between the lower ring and the upper ring.

In another embodiment, a non-pneumatic tire includes a lower ring having a first diameter and an upper ring having a second diameter greater than the first diameter. The upper ring is substantially coaxial with the lower ring. The non-pneumatic tire further includes a plurality of curved, steel spokes extending between the lower ring and the upper ring. Each of the plurality of curved, steel spokes has a 0.2% yield strength of at least 1300 MPA, a tensile strength of at least 1400 MPa, and a hardness of at least 50 HRC.

In yet another embodiment, a method of making a spoke for a nonpneumatic tire includes providing a rolled sheet of steel having a carbon content between 0.28% and 0.50%, unwinding the rolled sheet of steel, and roll forming the sheet of steel to form a curve along its width. The method also includes heating the sheet of steel to a temperature between 950° C. and 1400° C., during a period of 2 to 10 seconds, and cooling the sheet of steel to a temperature below 200° C. within 10 seconds. The method further includes cutting a steel spoke from the sheet of steel, the steel spoke having a width between 80 mm and 400 mm.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a front view of one embodiment of a non-pneumatic tire,

FIG. 2 is a flow chart illustrating one embodiment of a method of making a spoke for a non-pneumatic tire,

FIG. 3 is a pictorial illustration of the method shown in the flow chart of FIG. 2,

FIG. 4 is a flow chart illustrating an alternative embodiment of a method of making a spoke for a non-pneumatic tire, and

FIG. 5 is a pictorial illustration of the method shown in the flow chart of FIG. 4.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Tread” as used herein, refers to that portion of the tire that comes into contact with the road or ground under normal inflation and normal load.

While similar terms used in the following descriptions describe common tire components, it should be understood that because the terms carry slightly different connotations, one of ordinary skill in the art would not consider any one of the following terms to be purely interchangeable with another term used to describe a common tire component.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

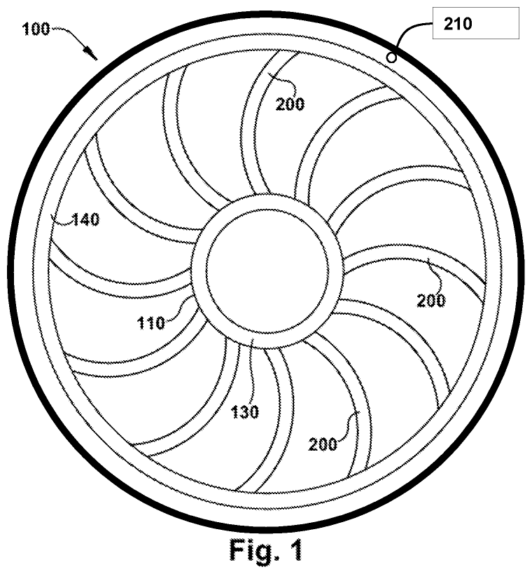

FIG. 1 illustrates a front view of one embodiment of a non-pneumatic tire 100. The non-pneumatic tire 100 includes a lower ring 130 having a first diameter, and an upper ring 140 having a second diameter greater than the first diameter. The upper ring 140 is coaxial with the lower ring 130. The lower ring 130 may engage a vehicle hub (not shown) for attaching the non-pneumatic tire 100 to a vehicle.

Spokes 200 extend between and connect the lower ring 130 to the upper ring 140. In the illustrated embodiment, the spokes 200 are curved. In an alternative embodiment, the spokes may have a more pronounced curve, such that they are substantially C-shaped. In other alternative embodiments, the spokes may have any desired shape. For example, the spokes may be substantially V-shaped or serpentine shaped. In still other alternative embodiments, the non-pneumatic tire may include spokes of two or more different shapes. For example, the non-pneumatic tire may include C-shaped spokes that alternate with V-shaped spokes along a circumferential direction of the non-pneumatic tire. In yet another alternative embodiment, the spokes may be replaced with a webbing or other support structure.

A circumferential tread 210 is attached to the upper ring 140. The circumferential tread 210 may be constructed of rubber or other elastomeric material, and may include tread elements (not shown) such as grooves, ribs, blocks, lugs, sipes, studs, or any other desired elements. In an alternative embodiment, the tread layer may be omitted and tread elements may be formed directly on the upper ring.

Other components of the non-pneumatic tire 100 may be made of various materials. The lower ring 130 or the upper ring 140 may be made of an elastomeric material, plastic, composite, or metal. The spokes 200 may also be made of an elastomeric material, plastic, composite, or metal. In alternative embodiments, the lower ring, the upper ring, or the tread band may be made of any desired material. Certain materials may be selected for certain components in order to provide the non-pneumatic tire with desired performance characteristics.

In some embodiments, it is desirable to construct spokes from very high strength steel. Forming very high strength steel into a curved shape (such as a constant radius) is difficult, however, because the steel tends to revert to its previous shape after bending. This property may be referred to as the “springback” of the steel. This tendency becomes increasingly more severe as the strength of the steel increases. Forming of very high strength steels requires much higher press forces than conventional steels, and thus requires the use of specialist high tonnage presses or rollforming equipment. This requirement for specialized equipment may considerably increase the cost of processing and thus may limit the number of companies with capability to produce such parts.

Due to its springback tendency, very high strength steels are often overbent past the desired shape to allow them to relax back to the desired shape. In practice, the relaxation is often inconsistent between different coils of steel, resulting in poor dimensional control. Thus, overbent steel components must often be re-tuned. The forming operation must also be adjusted to compensate for differences in springback between coils. Residual stresses from the forming process can also vary due to the forming and re-tuning processes, causing inconsistency in fatigue durability.

One known solution to this problem is to use a hot forming grade of steel which can be formed while hot and then quenched to form a martensitic structure with the required mechanical properties. One example of a hot forming grade of steel is Usibor grade press hardened steel from ArcelorMittal. This steel can only be used in a hot stamping process where individual flat blanks are heated to approximately 950° C. then quickly stamped in a die and rapidly cooled to below 200° C. while under pressure in the die to form individual spokes. This process is quite slow and expensive due to the high temperatures and complexity of the cooling systems required in the die.

Another known solution is to form the steel in a lower strength structure and then use a heat treatment process to increase the strength by changing the crystalline structure of the steel to a martensite or bainite. With conventional steels classified as high strength with ultimate tensile strengths of around 400 to 600 MPa, it is possible to roll form a bend or a C-shape in a continuous section and achieve consistent results. Adjustments to compensate for minor differences in strength between coils can be made using laser measurement systems and direct feedback to tighten or loosen the forming rolls. The process may be run from a coil of steel as a continuous process. The formed channel can then either be cut into individual components or as longer lengths. For practical reasons, handling of lengths greater than 4 or 5 m becomes very difficult.

Existing processes of roll forming steel and then heat treating the roll-formed steel can cause thermal distortion of the component as it is gradually heated up and residual stresses are relieved. Rapid cooling to ‘set’ the microstructure can then induce further residual stresses which can cause distortion or result in premature fatigue failure due to residual tensile stress concentrations in local areas. Taking steps such as clamping and supporting the component to prevent distortion can be successful, but this is expensive and impractical for high volume production.

An improved solution to the springback problem is disclosed herein. In this improved solution, the component is rapidly heated using induction heating and then rapidly cooled through water cooling or quenching. The process of rapidly heating and cooling the component within a few seconds creates a bainite structure within the steel. The rapid heating and rapid cooling—or flash processing—reduces the opportunity for thermal distortion or residual stresses to be generated. In one test, using a 4140 steel component, the flash process described above resulted in a large increase of strength compared to a conventional process, as shown in Table 1:

| | Conventional Process | Flash Process |
|---|---|---|
| Tensile Strength | 655 MPa | 1945 MPa |
| 0.2% Yield Strength | 415 MPa | 1596 MPa |
| Elongation | 25% | 9% |
| Hardness (HRC) | 13 | 54 |
| Hardness (Vickers) | 207 | 600 |

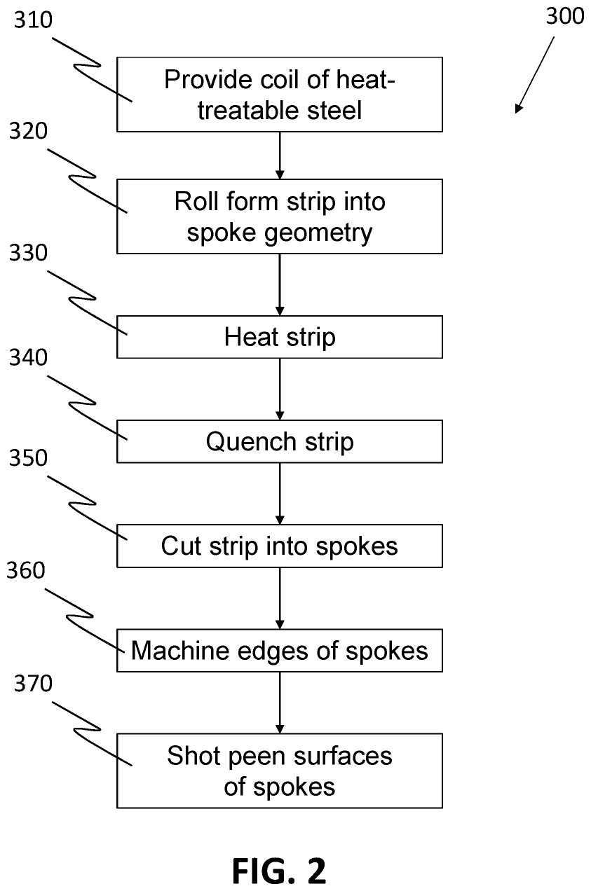

FIG. 2 is a flow chart illustrating one embodiment of such a method 300 of making a spoke for a non-pneumatic tire. The method 300 includes providing a rolled sheet of heat treatable steel (310). The sheet has a thickness between 1.5 mm and 7 mm. In one embodiment, the width of the sheet is 1.5 m or less.

In one embodiment, the heat treatable steel is 4130 steel. In alternative embodiments, the heat treatable steel may be 4140 or 4150 steel. The heat treatable steel may have a carbon content between 0.28% and 0.50%. In an alternative embodiment, the heat treatable steel may have a carbon content between 0.20% and 0.55%. In another alternative embodiment, the heat treatable steel may have a carbon content between 0.20% and 0.60%. The heat treatable steel may also have a manganese content between 0.40% and 1.0%.

While the disclosed process is described for very high strength steel, it should be understood that other steel options may be used, such as 1080 steel. Thus, in alternative embodiments, the process may be used with steel having a carbon content between 0.001% and 4.0%. Additionally, the process may be used with steel having a manganese content of 0.30% to 1.0%.

The rolled sheet of steel is unwound, and then roll formed to impart a curve, bend, or other geometry along its width. The roll forming process may form any desired spoke geometry in the strip (320). In one embodiment, an arc is formed in the strip, wherein the arc is defined by a single radius. In an alternative embodiment, a curve is formed in the strip, wherein the curve is defined by multiple radii. In another alternative embodiment, a V-shaped bend is formed in the strip. It should be understood that multiple arcs or bends may be formed in a strip.

The strip is then optionally pre-heated. In one embodiment, the strip is pre-heated to a temperature between 450° C. and 650° C. The pre-heating may be performed in an electric furnace or a gas furnace. The pre-heating step may also be omitted.

The strip is then heated to a temperature between 950° C. and 1400° C. (330). The strip may be heated to this temperature during a period of 2 to 10 seconds. Thus, this step may be referred to as a rapid heating step. The heating step may be performed in a heating unit. Exemplary heating units include, without limitation, electric resistance heaters, fluidized beds, electric furnaces, plasma furnaces, microwave ovens, open environment propane forges, gas fired units, solid fuels, high temperature salt baths, torches, induction heaters and any combination thereof.

After the strip is heated to a temperature between 950° C. and 1400° C., it is then cooled to a temperature below 200° C. (340). The strip may be cooled to this temperature within 10 seconds. Thus, this step may be referred to as a rapid cooling step. In one embodiment, the strip is cooled by quenching the strip in a quenchant. Exemplary quenchants include, without limitation, water, water-containing aqueous solutions, oil, brine solutions, air, and powders.

After the strip has been rapidly heated and then rapidly cooled, it is cut into a plurality of steel spokes (350). In one embodiment, each spoke has a width between 80 mm and 400 mm. However, it should be understood that the strip may be cut into any desired width.

After the strip has been cut, optional finishing processes may be applied. For example, at least one edge of a spoke may be machined (360). The machining process may impart a rounded or beveled edge. Alternatively, the machining may impart square corners or any geometric shape to the edge. As another example, one or more surfaces may be peened, such as through a shot peening or laser peening process (370). Those of ordinary skill in the art will understand that other known finishing processes may be applied to each spoke.

The spoke that results from this process has been shown to have a tensile strength of at least 1400 MPa, a 0.2% yield strength of at least 1300 MPA, and a hardness of at least 50 HRC. These properties may be varied by tuning any number of steps in the flash process.

After a plurality of spokes have been formed, a tire manufacturer may provide a lower ring having a first diameter and an upper ring having a second diameter greater than the first diameter. The tire manufacturer may then arrange the lower ring and upper ring such that they are coaxial, and extend the plurality of steel spokes between the lower ring and the upper ring. The plurality of spokes may be affixed to the lower and upper rings by a welding or brazing process. Alternatively, the plurality of spokes may be connected to the lower and upper rings by pins, adhesives or other fasteners. For example, the plurality of spokes may be hingedly connected to one or both of the lower ring and the upper ring. In one known embodiment, one or more of the upper ring and the lower ring may have slots to receive the spokes.

In assembling the spokes with the upper ring and lower ring, each spoke may extend axially across the entire width of the lower ring and the entire width of the upper ring. Alternatively, one or more of the spokes may extend across less than the entire width of the lower ring and the entire width of the upper ring. In certain embodiments, two or more rows of spokes may extend axially across the upper and lower rings. Where two or more rows of spokes are employed, the spokes of adjacent rows may have bends in the opposite direction. Alternatively, where two or more rows of spokes are employed, the spokes of adjacent rows may have bends in the same direction.

An elastomeric tread may then be extended about the upper ring. The resulting non-pneumatic tire may be similar to the non-pneumatic tire 100 shown in FIG. 1.

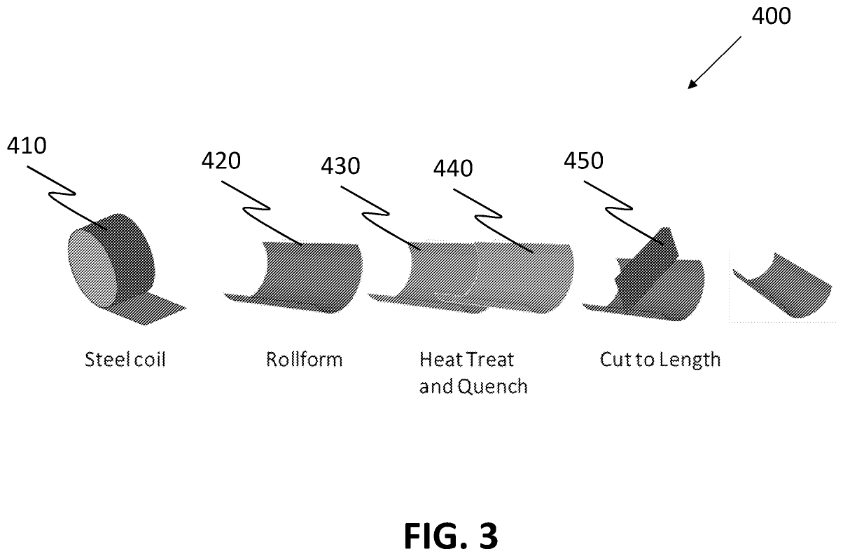

FIG. 3 is a pictorial illustration of a method of making a spoke (400). This method is substantially the same as the method 300 shown in the flow chart of FIG. 2. As can be seen in this illustration, the method 400 includes a step of providing a steel coil (410). The steel coil may have the same properties described above with respect to FIG. 2. The steel is then roll formed (420), rapidly heated (430), and quenched (440). The steel is then cut to a desired spoke length (450).

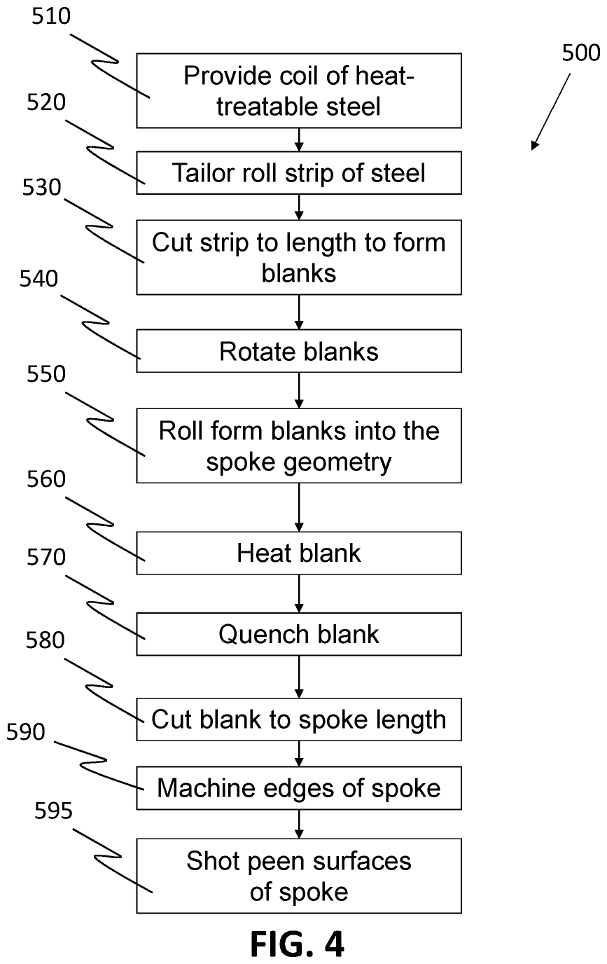

FIG. 4 is a flow chart illustrating an alternative embodiment of a method 500 of making a spoke for a non-pneumatic tire. The method 500 includes providing a rolled sheet of heat treatable steel (510). The sheet has a thickness between 1.5 mm and 7 mm. In one embodiment, the width of the sheet is 2.0 m or less.

In one embodiment, the heat treatable steel is 4130 steel. In alternative embodiments, the heat treatable steel may be 4140 or 4150 steel. The heat treatable steel may have a carbon content between 0.28% and 0.50%. In an alternative embodiment, the heat treatable steel may have a carbon content between 0.20% and 0.55%. In another alternative embodiment, the heat treatable steel may have a carbon content between 0.20% and 0.60%. The heat treatable steel may also have a manganese content between 0.40% and 1.0%.

While the disclosed process is described for very high strength steel, it should be understood that other steel options may be used, such as 1080 steel. Thus, in alternative embodiments, the process may be used with steel having a carbon content between 0.001% and 4.0%. Additionally, the process may be used with steel having a manganese content of 0.30% to 1.0%.

The rolled sheet of steel is unwound, and then tailor rolled (520). A tailor rolling process imparts a continuous thickness transition between a minimum thickness and a maximum thickness. In one embodiment, the sheet of steel is tailor rolled such that the thickness varies periodically along its length between a minimum thickness of 1.2 mm and a maximum thickness of 4.5 mm.

The sheet of steel is then cut into blanks containing one or more thick section and one or more thin section of steel (530). The blank may be cut so that its length is equal to the width of the coil. After each blank is cut, it is rotated 90 degrees (540).

The rotated blank is then roll formed to impart a curve, bend, or other geometry along its width. The roll forming process may form any desired spoke geometry in the blank (550). In one embodiment, an arc is formed in the blank, wherein the arc is defined by a single radius. In an alternative embodiment, a curve is formed in the blank, wherein the curve is defined by multiple radii. In another alternative embodiment, a V-shaped bend is formed in the blank. It should be understood that multiple arcs or bends may be formed in a blank.

The blank is then optionally pre-heated. In one embodiment, the blank is pre-heated to a temperature between 450° C. and 650° C. The pre-heating may be performed in an electric furnace or a gas furnace. The pre-heating step may also be omitted.

The blank is then heated to a temperature between 950° C. and 1400° C. (560). The blank may be heated to this temperature during a period of 2 to 10 seconds. Thus, this step may be referred to as a rapid heating step. The heating step may be performed in a heating unit. Exemplary heating units include, without limitation, electric resistance heaters, fluidized beds, electric furnaces, plasma furnaces, microwave ovens, open environment propane forges, gas fired units, solid fuels, high temperature salt baths, torches, induction heaters and any combination thereof.

After the blank is heated to a temperature between 950° C. and 1400° C., it is then cooled to a temperature below 200° C. (570). The blank may be cooled to this temperature within 10 seconds. Thus, this step may be referred to as a rapid cooling step. In one embodiment, the blank is cooled by quenching the blank in a quenching material. Exemplary quenching materials include, without limitation, water, water-containing aqueous solutions, oil, brine solutions, air, and powders.

After the blank has been rapidly heated and then rapidly cooled, it is cut into a plurality of steel spokes (580). In one embodiment, each spoke has a width between 80 mm and 400 mm. However, it should be understood that the blank may be cut into any desired width.

Due to the tailor rolling and the rotation of the blanks before the roll forming process, each blank has a thickness that varies along its length. In one embodiment, the thickness varies from a minimum thickness of 1.2 mm and a maximum thickness of 4.5 mm.

After the blank has been cut, optional finishing processes may be applied. For example, at least one edge of a spoke may be machined (590). The machining process may impart a rounded or beveled edge. Alternatively, the machining may impart square corners or any geometric shape to the edge. As another example, one or more surfaces may be peened, such as through a shot peening or laser peening process (595). Those of ordinary skill in the art will understand that other known finishing processes may be applied to each spoke.

The spoke that results from this process has been shown to have a tensile stress of at least 1400 MPa, a 0.2% yield strength of at least 1300 MPA, and a hardness of at least 50 HRC. These properties may be varied by tuning any number of steps in the flash process.

After a plurality of spokes have been formed, a tire manufacturer may provide a lower ring having a first diameter and an upper ring having a second diameter greater than the first diameter. The tire manufacturer may then arrange the lower ring and upper ring such that they are coaxial, and extend the plurality of steel spokes between the lower ring and the upper ring. The plurality of spokes may be affixed to the lower and upper rings by a welding or brazing process. Alternatively, the plurality of spokes may be connected to the lower and upper rings by pins, adhesives or other fasteners. For example, the plurality of spokes may be hingedly connected to one or both of the lower ring and the upper ring. In one known embodiment, one or more of the upper ring and the lower ring may have slots to receive the spokes.

In assembling the spokes with the upper ring and lower ring, each spoke may extend axially across the entire width of the lower ring and the entire width of the upper ring. Alternatively, one or more of the spokes may extend across less than the entire width of the lower ring and the entire width of the upper ring. In certain embodiments, two or more rows of spokes may extend axially across the upper and lower rings. Where two or more rows of spokes are employed, the spokes of adjacent rows may have bends in the opposite direction. Alternatively, where two or more rows of spokes are employed, the spokes of adjacent rows may have bends in the same direction.

An elastomeric tread may then be extended about the upper ring. The resulting non-pneumatic tire may be similar to the non-pneumatic tire 100 shown in FIG. 1. It should be understood that the method 500 of FIG. 4 is merely exemplary. In alternative embodiments, certain steps may be omitted. For example, the strip may be cut into blanks without performing a tailor rolling process.

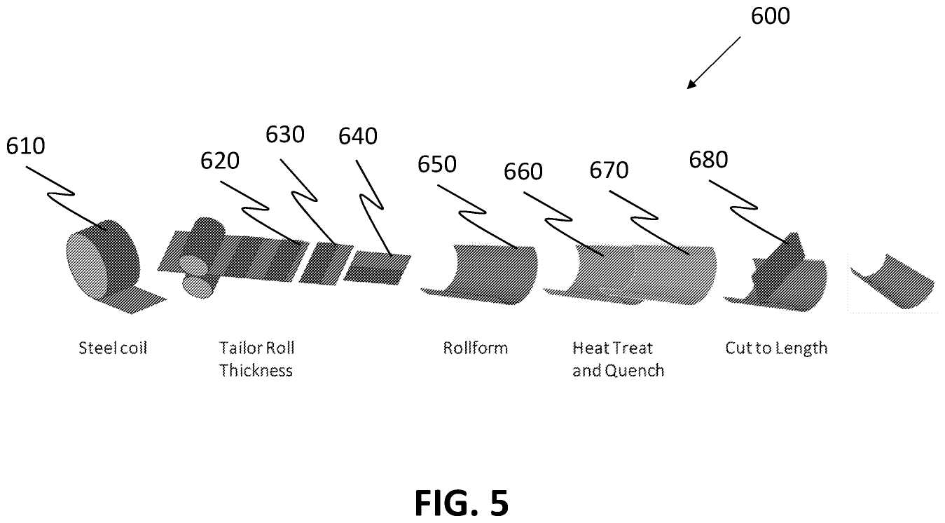

FIG. 5 is a pictorial illustration of a method of making a spoke (600). This method is substantially the same as the method 500 shown in the flow chart of FIG. 4. As can be seen in this illustration, the method 600 includes a step of providing a steel coil (610). The steel coil may have the same properties described above with respect to FIG. 4. The steel coil is tailor rolled (620), cut (630), and rotated (640). The steel is then roll formed (650), rapidly heated (660), and quenched (670). The steel is then cut to a desired spoke length (680).

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of making a nonpneumatic tire, the method comprising:
providing a rolled sheet of steel having a carbon content between 0.20% and 0.60%, the sheet having a thickness between 1.5 mm and 7 mm;
unwinding the rolled sheet of steel;
tailor rolling the sheet of steel, such that the thickness of the sheet varies periodically along its length between a minimum thickness and a maximum thickness,
wherein the minimum thickness is at least 1.2 mm, and
wherein the maximum thickness is no more than 4.5 mm;
cutting the sheet into blanks containing one or more thick section and one or more thin section of steel, wherein the length of each blank is equal to the width of the sheet;
rotating each blank through 90 degrees;
roll forming each blank to form a curve along its width, with one or more thick section and one or more thin section in parallel along the length of the blank;
heating each blank to a temperature between 950° C. and 1400° C., during a period of 2 to 10 seconds;
cooling each blank to a temperature below 200° C. within 10 seconds;
cutting each blank into a plurality of steel spokes having a width between 80 mm and 400 mm;
providing a lower ring and an upper ring;
arranging the plurality of steel spokes between the lower ring and the upper ring.

2. The method of claim 1, wherein the step of heating each blank includes heating each blank with a heating unit selected from the group consisting of electric resistance heaters, fluidized beds, electric furnaces, plasma furnaces, microwave ovens, open environment propane forges, gas fired units, solid fuels, high temperature salt baths, torches, induction heaters and any combination thereof.

3. The method of claim 1, wherein the step of cooling each blank includes rapidly quenching the blank with a quenching material selected from the group consisting of water, water-containing aqueous solutions, oil, brine solutions, air, and powders.

4. The method of claim 1, further comprising a step of machining at least one edge of each of the plurality of steel spokes.

5. The method of claim 1, further comprising a step of peening at least one surface of each of the plurality of steel spokes.

6. The method of claim 1, wherein the steps of heating and cooling each blank results in a blank having a tensile strength of at least 1400 MPa.

7. The method of claim 1, wherein the steps of heating and cooling each blank results in a blank having a 0.2% yield strength of at least 1300 MPA.

8. The method of claim 1, wherein the steps of heating and cooling each blank results in a sheet of steel having a hardness of at least 50 HRC.

9. The method of claim 1, further comprising placing a tread circumferentially about the upper ring.

10. The method of claim 1, further comprising pre-heating each blank to a temperature between 450° C. and 650° C., prior to the heating of each blank to a temperature between 950° C. and 1400° C.

11. The method of claim 10, wherein pre-heating of the blank to a temperature between 450° C. and 650° C. is performed with one of an electric furnace and a gas furnace.

12. A non-pneumatic tire comprising:
a lower ring having a first diameter;
an upper ring having a second diameter greater than the first diameter, the upper ring being substantially coaxial with the lower ring; and
a plurality of curved, steel spokes extending between the lower ring and the upper ring,
wherein each of the plurality of curved, steel spokes has a 0.2% yield strength of at least 1300 MPA, a tensile strength of at least 1400 MPa, and a hardness of at least 50 HRC.

13. The non-pneumatic tire of claim 12, wherein each of the plurality of curved, steel spokes has a carbon content between 0.28% and 0.50%.

14. The non-pneumatic tire of claim 12, wherein at least one of the plurality of curved, steel spokes has a variable thickness.

15. The non-pneumatic tire of claim 14, wherein the at least one of the plurality of curved, steel spokes having a variable thickness has a minimum thickness of 1.2 mm and a maximum thickness of 4.5 mm.

16. A method of making a spoke for a nonpneumatic tire, the method comprising:
providing a rolled sheet of steel having a carbon content between 0.28% and 0.50%;
unwinding the rolled sheet of steel;
roll forming the sheet of steel to form a curve along its width;
heating the sheet of steel to a temperature between 950° C. and 1400° C., during a period of 2 to 10 seconds;
cooling the sheet of steel to a temperature below 200° C. within 10 seconds;
cutting a steel spoke from the sheet of steel, the steel spoke having a width between 80 mm and 400 mm.

17. The method of claim 16, wherein the width of the sheet of steel is 1.5 m or less.

18. The method of claim 16, further comprising pre-heating the sheet of steel to a temperature between 450° C. and 650° C., prior to the heating of the sheet of steel to a temperature between 950° C. and 1400° C.

19. The method of claim 18, wherein pre-heating of the sheet of steel to a temperature between 450° C. and 650° C. is performed with one of an electric furnace and a gas furnace.

20. The method of claim 16, further comprising:
machining at least one edge of the steel spoke; and
peening at least one surface of the steel spoke.
